(19) United States
(12) Patent Application Publication
(10) Pub. No.: US 2002/0096569 A1
(43) Pub. Date: Jul. 25, 2002

(54) Data card including a magnetic strip having a textured surface or interface

(76) Inventors: Zine-Eddine Boutaghou, Vadnais Heights, MN (US); Catalin I. Serpe, Minnetonka, MN (US)

Correspondence Address: Deirdre Megley Kvale, Westman, Champlin & Kelly, International Centre, Suite 1600, 900 Second Avenue South, Minneapolis, MN, 55402-3319, US

(21) Appl. No.: 10/056,717

(22) Filed: Jan. 25, 2002

Related U.S. Application Data
(60) Provisional application No. 60/264,193, filed on Jan. 25, 2001.

(51) Int. Cl. G06K 19/06

(52) U.S. Cl. 235/493

(57) ABSTRACT

A data storage card including a magnetic data strip including a textured surface or interface. The textured surface or interface includes a plurality of spaced bumps. In one embodiment the magnetic data strip includes a textured substrate layer to form the textured surface or in an alternate embodiment, a protective layer of the magnetic strip is textured. In another embodiment, the magnetic strip is retractable into a body of a card and a surface or rail of the card along which the magnetic strip slides is textured.

### CROSS-REFERENCE TO RELATED APPLICATION

This application claims priority from U.S. Provisional Application Serial No. 60/264,193 filed on Jan. 25, 2001 for inventors Zine-Eddine Boutaghou and Catalin loan Serpe and entitled “REDUCED STICTION AND FRICTION ON MAGNETIC STORAGE DEVICE”.

### FIELD OF THE INVENTION

The present invention relates generally to a card including a magnetic strip, and more particularly but not by limitation to a textured surface structure or interface for a magnetic strip.

### BACKGROUND OF THE INVENTION

Data cards with magnetic strips are well known and include various applications for, but not limited to bank cards, pre-paid telephone or photocopy cards, automatic teller cards (ATM). Such magnetic cards include a magnetic strip which includes a magnetizable material which can store digital information such as account or personal information. Information is read or retrieved from the magnetic strip by a magnetic card reader. More sophisticated cards such as smart cards include processor chips and/or other enhancement features such as integrated displays and input functions or keys.

The magnetic strip is susceptible to damage and wear by frequent use or abuse. Cards with retractable magnetic strips are constructed so that the magnetic strip is retractable into the body of the card to protect the magnetic strip from contamination and damage and is extendable for use. Slideable movement of the magnetic strip between a retracted position in the body of the card and an extended position for use can introduce wear and damage to the magnetic strip and magnetic film media. Embodiments of the present invention provide solutions to these and other problems, and offer other advantages over the prior art.

### SUMMARY OF THE INVENTION

The present invention relates to a data storage card including a magnetic data strip including a textured surface or interface. The textured surface or interface includes a plurality of spaced bumps on the surface. In one embodiment the magnetic data strip includes a textured substrate layer to form the textured surface or in an alternate embodiment, a protective layer of the magnetic strip is textured. In another embodiment, the magnetic strip is retractable into a body of the card and a surface or rail of the card along which the magnetic strip slides is textured. Other features and benefits that characterize embodiments of the present invention will be apparent upon reading the following detailed description and review of the associated drawings.

### BRIEF DESCRIPTION OF THE DRAWINGS

FIG. 1 is a schematic illustration of a data storage card including a magnetic strip.

FIG. 2 is an illustrative embodiment of a layer construction for a magnetic strip of a data storage card having a textured surface.

FIG. 3 is an illustrative embodiment of a layer construction for a magnetic strip of a data storage card having a textured surface.

FIG. 4 is an illustrative plan view of an embodiment of bumps formed in a relatively smooth surface of a magnetic strip.

FIG. 5 is a schematic illustration of an embodiment of a data storage card including a retractable magnetic strip.

FIG. 6 is a side schematic illustration of an embodiment of a data storage card including a retractable magnetic strip.

FIG. 7 is a schematic illustration of a retractable magnetic strip slidably disposed between opposed card layers.

FIG. 8 is a schematic illustration of a textured interface for a retractable magnetic strip having a textured active surface.

FIG. 9 is a schematic illustration of a textured interface for a retractable magnetic strip including a textured card surface.

FIG. 10 is a schematic illustration of an embodiment of a textured interface for a retractable magnetic strip including a textured magnetic strip surface and textured card surface.

FIG. 11 is a schematic illustration of an embodiment of a retractable magnetic strip including a surface texture over an entire surface of the magnetic strip.

FIG. 12 is a schematic illustration of an embodiment of a retractable magnetic strip including a surface texture along edge portions of the magnetic strip.

FIG. 13 is a cross-sectional view of a portion the magnetic strip of FIG. 12 as taken along line 13-13 of FIG. 12.

FIG. 14 is a schematic illustration of an embodiment of a retractable magnetic strip slideable along rails.

FIG. 15 illustrates a magnetic strip portion slideable along a textured rail surface.

FIG. 16 is a flow chart illustrating a fabrication embodiment of a textured interface for a magnetic strip of a data storage card.

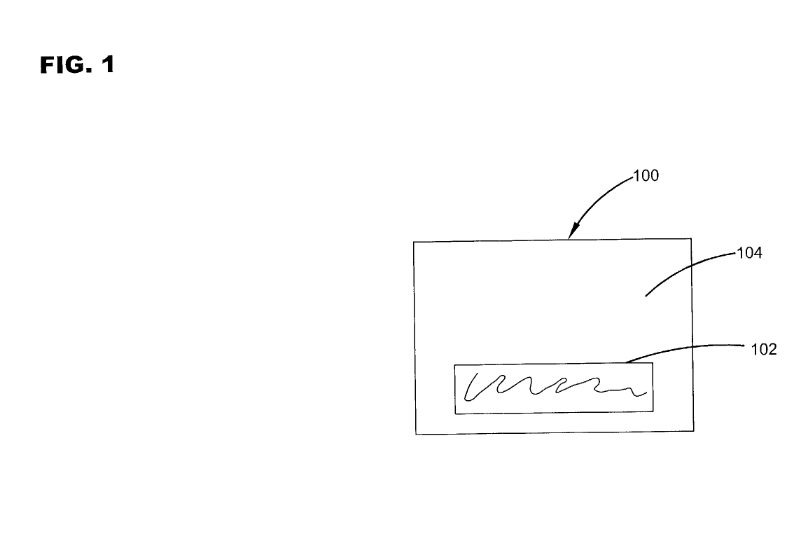

### DETAILED DESCRIPTION OF ILLUSTRATIVE EMBODIMENTS

Data storage cards 100 include a magnetic strip 102 carried on a non-conductive card 104, typically formed of a plastic or composite material. The magnetic strip 102 is encoded with information or data, such as commercial account information or personnel data which can be accessed by a card reader, such as an automatic teller machine for commercial or banking transactions. Applications of data storage cards 100 include by way of example ATM cards or credit cards which include magnetic strips 104 carried by a form factor dimensioned card 104. As previously described, the magnetic strip 102 of the data storage card 100 is subjectable to wear and damage. The present invention generally relates to a textured surface structure or interface to reduce wear and damage to the magnetic strip.

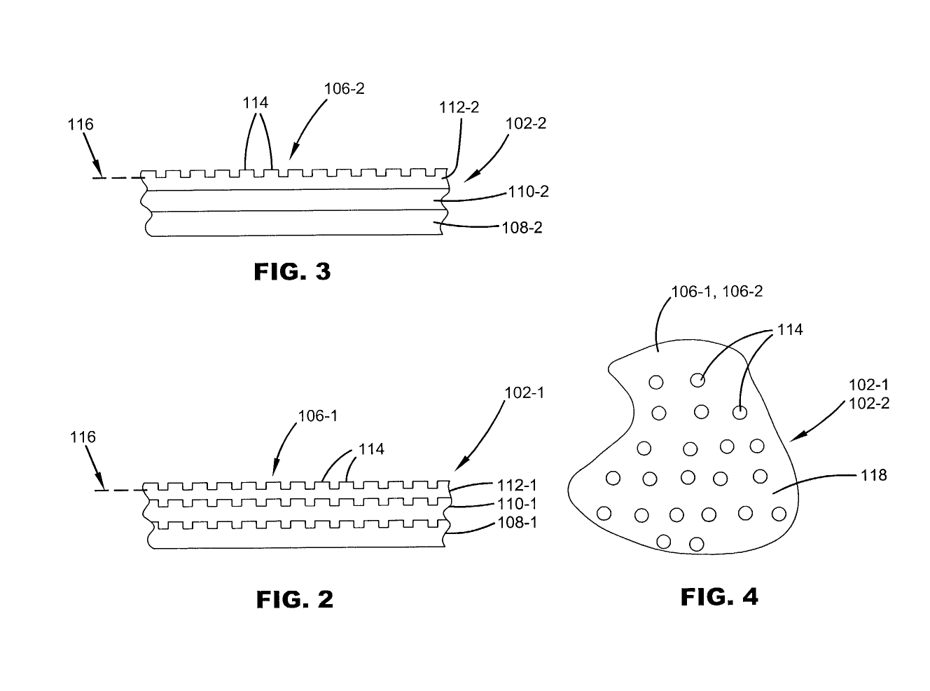

FIGS. 2-3 illustrate embodiments of a magnetic strip 102-1, 102-2 having an exposed textured surface 106-1, 106-2. As shown in one embodiment illustrated in FIG. 2, the textured surface 106-1 is fabricated on a textured substrate 108-1 and a magnetic layer or film 110-1 is deposited over the textured substrate 108-1 to form a textured magnetic layer 110-1. In the embodiment illustrated in FIG. 2, a protective layer 112-1 is deposited over the textured magnetic layer 110-1 to form the textured surface 106-1 of the magnetic strip 102-1. In another embodiment illustrated in FIG. 3, a magnetic film layer 110-2 is deposited on a non-textured substrate 108-2 and a protective layer 112-2 is deposited over the magnetic layer 110-2. As shown, the protective layer 112-2 is textured to form the textured surface 106-2 as described.

The textured surfaces 106-1, 106-2 shown in FIGS. 2-3 includes a plurality of spaced micro-sized bumps 114 extending above a mean surface plane 116 to form a micro-textured pattern over a surface 118 of the magnetic strip as shown in FIG. 4. The pattern of bumps 114 can have a uniform, regular or random size, distribution or spacing. Further bumps are not limited to any particular shape or configuration, for example, bump can be circular, square, elliptical or ring-shaped. The bumps 114 extend above the mean surface plane 116 to reduce contact area of the magnetic strip 102. The height of the bumps 118 is in the range of nanometers and the bumps 114 are spaced and shaped to provide optimum friction and wear levels for normal operating loads.

The bumps 114 are formed on a relatively smooth surface 118 of the magnetic strip having a relatively low roughness average Rₐ. The bumps 114 are formed by known laser patterning techniques or known photolithography or etching processes as opposed to mechanical grinding techniques which provide a rough surface with sharp peaks and valleys. Bumps can be laser formed in a surface of the magnetic strip to provide a stiction and abrasive resistant surface. In particular, as previously described bumps 114 can be formed on a relatively smooth surface of a substrate or protective layer to form the textured interface surface.

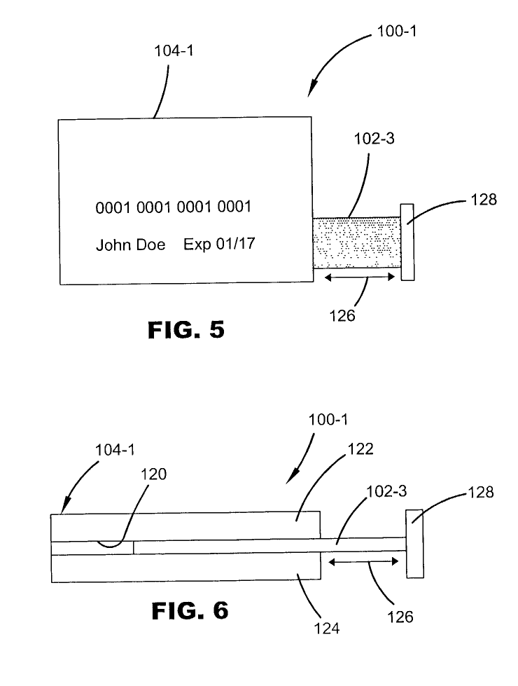

FIGS. 5-6 illustrate a magnetic card 100-1 including a retractable magnetic strip 102-3 with strip 102-3 shown in an extended position in FIG. 5. The magnetic strip 102-3 is retracted to protect the magnetic strip 102-3 from contamination and damage to the recording media. As schematically shown in the illustrated embodiment of FIG. 6, magnetic strip 102-3 is slidably disposed in a slot 120 between multiple card layers 122, 124 forming card 104-1. The magnetic strip 102-3 is slideably moved between a retracted position (not shown) to an extended position shown as illustrated by arrow 126. As shown in the embodiment of FIGS. 5-6, the magnetic strip 102-3 is moved between the retracted position and the extended position using handle 128. Thus, the magnetic strip 102-3 is extended for use and retracted for transport to limit damage and wear.

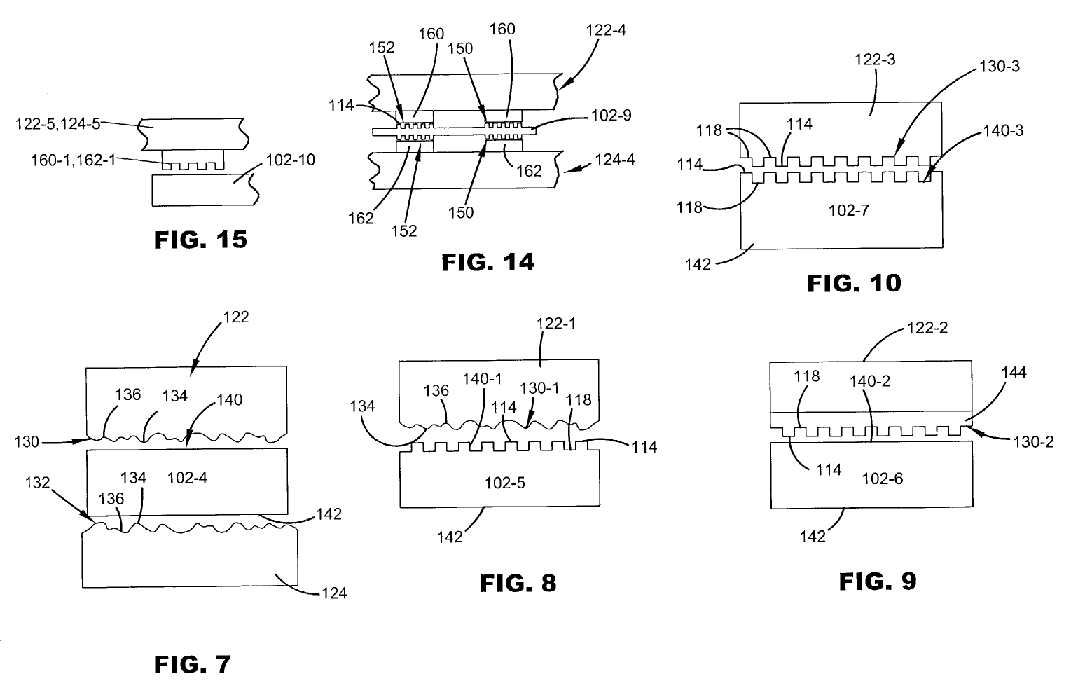

In one embodiment illustrated in FIG. 7, magnetic strip 102-4 includes an active surface 140 for magnetically encoding data or information and a non-active surface 142. Sliding movement between surfaces 140, 142 of the magnetic strip 102-4 and card layers 122, 124 creates stiction and friction between the strip 102-4 and card layers 122, 124 and introduces abrasion or wear to the magnetic strip and magnetic film media. In particular, as illustrated in FIG. 7, card layers 122, 124 can include rough surfaces 130, 132 having random peaks 134 and valleys 136 as shown. Stiction or friction between the magnetic strip and rough surfaces of the card can damage or wear the magnetic strip 102-4. In particular, friction between the peaks 134 or roughened surfaces and the magnetic strip 102-4 can wear or abrade the magnetic strip. Damage to the magnetic strip and in particular, the active surface 140 can result in loss of encoded data or information.

FIGS. 8-10 illustrate embodiments of textured surface structures or textured interfaces to reduce stiction, abrasion and wear as previously discussed. As shown textured surfaces include a plurality of spaced bumps 114 extending above surface 116 to reduce the interface area for the sliding surfaces to reduce stiction, abrasion and wear. In the embodiment illustrated in FIG. 8, active layer 140-1 of magnetic strip 102-5 includes a textured surface including a plurality of bumps 118 to provide a textured interface between the sliding surfaces of the card 130-1 and magnetic strip 102-5.

In the embodiment of FIG. 9, card surface 130-2 includes a textured surface to reduce contact area between a non-textured surface 140-2 of magnetic strip 102-6 and the card to reduce friction and stiction and in the embodiment of FIG. 10, both the active layer 140-3 of magnetic strip 102-7 and surface 130-3 of the card are textured to reduce contact area, stiction and wear. Although in the illustrated embodiments only the active surface of the magnetic strip is textured, alternatively the non-active surface 142 can be similarly textured or the magnetic strip can include opposed active surfaces which are textured to reduce damage or wear.

As previously described, the magnetic strip is formed of a composite structure and different layers of the magnetic strip can be textured to provide the textured surface. In particular, a substrate layer of the magnetic strip can be textured or a protective layer of the magnetic strip can be textured. For example, the magnetic strip can include a relatively smooth substrate layer of glass, aluminum or plastic material and the bumps can be formed in the substrate layer by known techniques to form the textured surface as described. Alternatively a protective layer such a diamond like carbon which is deposited over a magnetic film layer can be textured as previously discussed. Similarly, the textured surface can be formed in card layers by known fabrication processes. For example, in the one embodiment illustrated in FIG. 9, card layer 122-2 can include a protective layer 144 having bumps 114 formed therein to form the textured interface surface 130-2 as described.

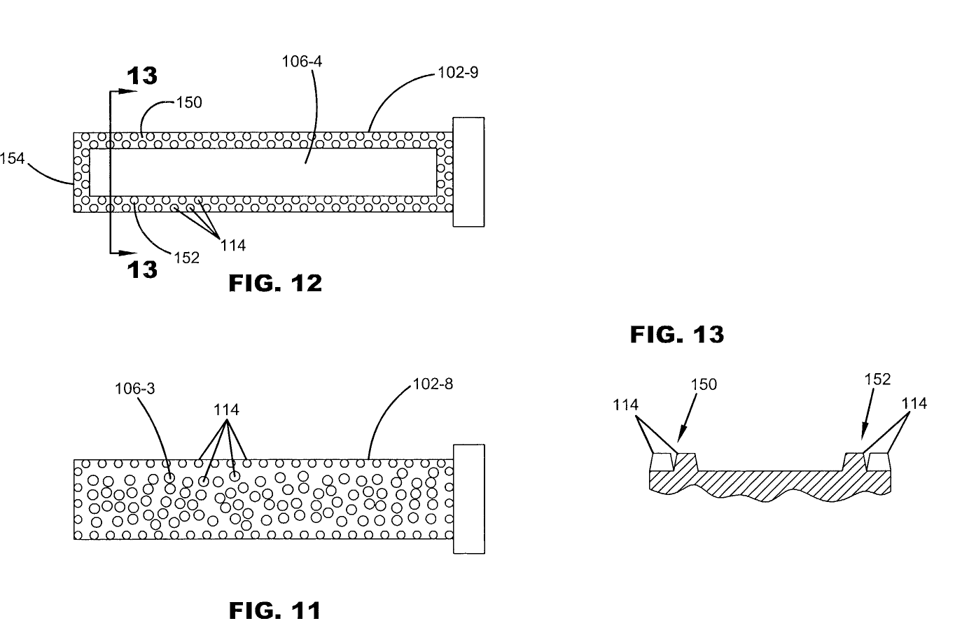

In the embodiment illustrated in FIG. 11, an entire surface 106-3 of the magnetic strip 102-8 is textured. Alternatively a portion of the surface 106-4 of the magnetic strip 102-9 can be textured as illustrated in FIGS. 12 and 13. For example, edge portions of the surface 106-4 of magnetic strip 102-9 can slide along rails 160, 162 of the card layers 122-4, 124-4 as shown in FIG. 14 and edge portions 150, 152 and/or 154 of surface 106-4 of the magnetic strip 102-9 are textured to reduce stiction and wear as described. As shown in FIGS. 13-14, bump 114 can include rounded edges and in the illustrated embodiment are circular shaped. In the illustrated embodiment of FIG. 15 rails 160-1, 162-1 of the card layers 122-5, 124-5 are textured to provide the sliding textured interface betweeen the magnetic strip 102-10 and the card layers.

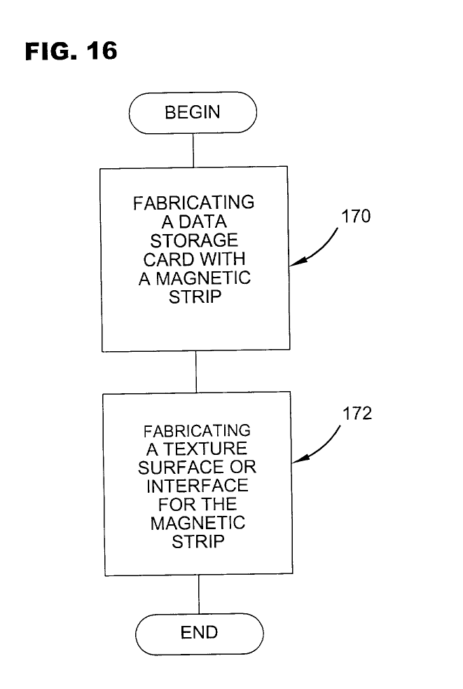

FIG. 16 is a flow chart schematically illustrating fabrication of the textured interface or surface of the present invention. As illustrated by block 170, a data storage card having a magnetic strip is fabricated and as illustrated by block 172, a textured surface or interface is fabricated for the magnetic strip. In particular, as previously described, the textured surface can be fabricated on the magnetic strip, for example in a substrate or protective layer. Alternatively, the textured interface or surface can be fabricated on interface surfaces of the data storage card slideable engageable with the magnetic strip to reduce friction, stiction and wear.

A data storage card (such as 100, 100-1 ) including a magnetic data strip (such as 102, 102-1, et seq ) including a textured surface or interface (such as 106, 106-1 et seq, 130-2, 130-3, 140-1, 140-3). The textured surface or interface includes a plurality of spaced bump (such as 114) on surface (such as 118). In one embodiment the magnetic data strip (such as 102-1) includes a textured substrate layer (such as 108-1) to form a textured surface or alternatively in an alternate embodiment, a protective layer (such as 112-2) of the magnetic strip (such as 102-2) is textured. In another embodiment, the magnetic strip (such as 102-6, 102-7 ) is retractable into a body of a card and a surface or rail (such as 130-2, 130-3, 160-1, 162-1) of the card along which the magnetic strip slides is textured.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the preferred embodiment described with reference to a particular application it will be appreciated by those skilled in the art that the teachings of the present invention can be applied to many data storage card including for example a smart card which includes a processor or other enhancements, without departing from the scope and spirit of the present invention.

What is claimed is:

1. A data storage device comprising:
a card formed of a non-conductive material; and
a magnetic strip carried on the card and including a substrate layer and a magnetizable layer encodable to store digital information and the magnetic strip including a surface and the surface including a textured portion having a plurality of spaced bumps on a relatively smooth surface of the magnetic strip.

2. The data storage device of claim 1 wherein the substrate layer includes a surface texture including a plurality of spaced bumps on a portion thereof to form the textured portion of the surface of the magnetic strip.

3. The data storage device of claim 1 wherein the magnetic strip includes a protective layer covering the magnetizable layer and the protective layer includes a surface texture including a plurality of spaced bumps to form the textured portion of the surface of the magnetic strip.

4. The data storage device of claim 3 wherein the protective layer is formed of a diamond-like carbon.

5. The data storage device of claim 1 wherein the substrate layer is formed of a material selected from the group consisting of aluminum, glass or plastic.

6. The data storage device of claim 1 wherein the plurality of spaced bumps on the textured portion of the surface of the magnetic strip are laser formed.

7. The data storage device of claim 1 wherein the plurality of spaced bumps have a relatively uniform size.

8. The data storage device of claim 1 wherein the plurality of bumps are relatively uniformly spaced.

9. The data storage device of claim 1 wherein the magnetic strip includes an active surface and the active surface includes the textured portion including the plurality of spaced bumps.

10. A data storage device comprising:
a card formed of a non-conductive material including a magnetic strip; and
interfacing means for providing a textured interface for the magnetic strip.

11. The data storage device of claim 10 wherein the magnetic strip includes a textured substrate surface including a plurality of spaced bumps to form the interfacing means for providing the textured interface for the magnetic strip.

12. The data storage device of claim 10 wherein the magnetic strip includes a textured protective layer surface including a plurality of spaced bumps to form the interfacing means for providing the textured interface for the magnetic strip

13. The data storage device of claim 10 wherein a surface of the card includes a textured portion including a plurality of spaced bumps to form the interfacing means for providing the textured interface for the magnetic strip.

14. A data storage device comprising:
a card formed of a non-conductive material; and
a magnetic strip slidably in a body of the card and movable between a retracted position and an extended position and the magnetic strip including a substrate layer and a magnetizable layer encodable to store digital information and the magnetic strip including an interface surface slideable relative to an interface surface of the body of the card and at least one of the interface surfaces of the magnetic strip or the body of the card including a textured portion including a plurality of spaced bumps on a relatively smooth surface portion.

15. The data storage device of claim 14 wherein the magnetic strip includes an active surface and a portion of the active surface includes the textured portion including the plurality of spaced bumps.

16. The data storage device of claim 14 wherein the body of the card includes multiple card layers and a surface of the multiple card layers includes the textured portion including the plurality of spaced bumps.

17. The data storage device of claim 16 wherein the multiple card layers of the body of the card include opposed rails and the textured portion including the plurality of spaced bumps is formed on the opposed rails.

18. A method of fabricating a magnetic storage device comprising steps of:
fabricating a card formed of a non-conductive material including a magnetic strip; and
fabricating a textured surface portion including a plurality of spaced bumps formed in a relatively smooth surface portion on one of the magnetic strip or a body surface of the card.

19. The method of claim 18 wherein the step of fabricating the textured surface portion including the plurality of spaced bumps comprises the step of:
laser forming the plurality of spaced bumps.

20. The method of claim 18 wherein the magnetic strip includes an active surface and the step of fabricating the textured surface portion including the plurality of spaced bumps comprises the step of:
texturing the active surface of the magnetic strip.

21. The method of claim 18 wherein the magnetic strip includes an active surface slideable along the body surface of the card and the step of fabricating the textured surface portion including the plurality of spaced bumps comprises the step of:
texturing the body surface of the card having the active surface of the magnetic strip slideable therealong.

22. The method of claim 18 wherein the magnetic strip includes a magnetizable layer deposited on a substrate and the step of fabricating the textured surface portion including the plurality of spaced bumps comprises the step of:
texturing a surface portion of the substrate of the magnetic strip prior to depositing the magnetizable layer.
